(19) United States
(12) Patent Application Publication
(10) Pub. No.: US 2006/0132141 A1
(43) Pub. Date: Jun. 22, 2006

(54) Battery monitoring system and method

(75) Inventors: Thomas J Dougherty, Waukesha, WI (US); William J. Wruck, Whitefish Bay, WI (US); Chih Y. Chen, Oak Creek, WI (US)

Correspondence Address: FOLEY & LARDNER LLP, 777 EAST WISCONSIN AVENUE, SUITE 3800, MILWAUKEE, WI, 53202-5308, US

(73) Assignee: Johnson Controls Technology Company

(21) Appl. No.: 10/540,318

(22) PCT Filed: Dec. 30, 2003
(86) PCT No.: PCT/US03/41563

§ 371 Date: Nov. 30, 2005

Related U.S. Application Data
(60) Provisional application No. 60/437,870, filed on Jan. 3, 2003.

(51) Int. Cl. G01N 27/416

(52) U.S. Cl. 324/435

(57) ABSTRACT

A battery monitoring system includes a component for determining the magnitude of current flowing through a battery cable based on a magnetic field produced by the current. The component is configured to provide an output signal representative of the magnitude of current for use in characterizing the battery. A method for characterizing a battery utilizing a battery monitoring system includes inferring a magnitude of battery current based on a magnetic field generated by current flowing through a battery cable coupled to the battery. The battery monitoring system is adapted to characterize the battery utilizing at least one mathematical construct.

### CROSS-REFERENCE TO RELATED PATENT APPLICATIONS

This application claims the benefit of U.S. Provisional Patent Application No. 60/437,870, filed Jan. 3, 2003, which is incorporated herein by reference in its entirety.

### FIELD

The present invention relates to battery monitoring systems and methods. The present more specifically relates to battery monitoring systems and methods which provide enhanced accuracy for battery current measurements.

### BACKGROUND

Battery monitoring systems utilize various mathematical constructs (e.g., parameters, algorithms, transfer functions, etc.) to characterize (e.g., monitor, model, simulate, etc.) the performance, operation, and/or other characteristics of a battery (e.g., a lead-acid vehicle battery). Such a battery monitoring system may include electronics and modules as described in U.S. patent application Ser. No. 10/007,320, the disclosure of which is incorporated herein by reference.

Certain battery monitoring systems may utilize a calculated current, as opposed to a measured current. It may therefore be desirable to assess the accuracy of the values obtained for the calculated current. One method by which such assessment might be accomplished is to measure current directly (e.g., as with a shunt). Such method may undesirably increase the expense of manufacturing the battery monitoring system.

It would therefore be advantageous to provide a system and method for assessing the accuracy of current values calculated based on one or more measured voltage values for a battery. It would also be advantageous to provide a battery monitoring system that more accurately determines the current through a battery cable for use in modeling or simulating the performance, operation, and/or other characteristics of a battery. It would further be advantageous to provide a battery monitoring system that utilizes relatively accurate current values without the need to directly measure current (e.g., with a shunt). It would be desirable to provide a system and/or method having any one or more of these or other advantageous features.

### SUMMARY

The present invention relates to a battery monitoring system includes a component for determining the magnitude of current flowing through a battery cable based on a magnetic field produced by the current. The component is configured to provide an output signal representative of the magnitude of current for use in characterizing the battery.

The present invention also relates to a method for characterizing a battery utilizing a battery monitoring system includes inferring a magnitude of battery current based on a magnetic field generated by current flowing through a battery cable coupled to the battery. The battery monitoring system is adapted to characterize the battery utilizing at least one mathematical construct.

### BRIEF DESCRIPTION OF THE DRAWINGS

FIG. 1 is an exploded perspective view of a battery monitoring system according to an exemplary embodiment.

FIG. 2 is a side elevational view of the battery monitoring system shown in FIG. 1.

FIG. 3 is another side elevational view of the battery monitoring system shown in FIG. 1.

FIG. 4 is another exploded perspective view of the battery monitoring system shown in FIG. 1.

FIG. 5 is a perspective view of a battery monitoring system according to another exemplary embodiment.

FIG. 6 is a side elevational view of the battery monitoring system shown in FIG. 5, taken across line 6-6 in FIG. 7.

FIG. 7 is another side elevational view of the battery monitoring system illustrated in FIG. 5.

FIG. 8 is a schematic block diagram of a vehicle electrical system according to an exemplary embodiment.

FIG. 9 is a schematic block diagram of a vehicle electrical system according to another exemplary embodiment.

### DETAILED DESCRIPTION OF THE PREFERRED AND EXEMPLARY EMBODIMENTS

According to an exemplary embodiment, a system or device such as a battery monitoring or management system 10 (FIG. 1) uses various mathematical constructs (e.g., parameters, algorithms, transfer functions, etc.) to characterize (e.g., monitor, model, simulate, etc.) the performance, operation, and/or other characteristics of a battery (e.g., a lead-acid battery for use in vehicle starting, lighting, and ignition applications, commercial battery, marine battery, industrial battery, etc.). For example, a battery monitoring system may provide an indication of the amount of deliverable power or energy at a particular moment, and may also indicate any of a variety of other battery characteristics.

Battery monitoring system 10 may also be used in conjunction with one or more other systems configured to alter the state of the battery (e.g., where the model indicates that the battery has discharged to a predetermined point, a charging current may be introduced to the battery). Various other features of battery monitoring systems are described in detail in U.S. patent application Ser. No. 10/007,320, the disclosure of which is incorporated herein by reference.

According to an exemplary embodiment, battery monitoring system 10 is configured or adapted to estimate the deliverable power or energy for the battery, along with other battery performance and/or operational characteristics. The battery monitoring system may also utilize a visual analog representation to represent various battery performance and/or operational characteristics.

Battery monitoring system 10 utilizes various static and dynamic inputs for the various algorithms or transfer functions used to model or simulate the battery to which the battery monitoring system is coupled. One such dynamic input is the voltage of the battery during charging and/or discharging, from which charging and/or discharging current may be calculated (e.g., based on one or more mathematical formulae representative of the relationship between voltage and current).

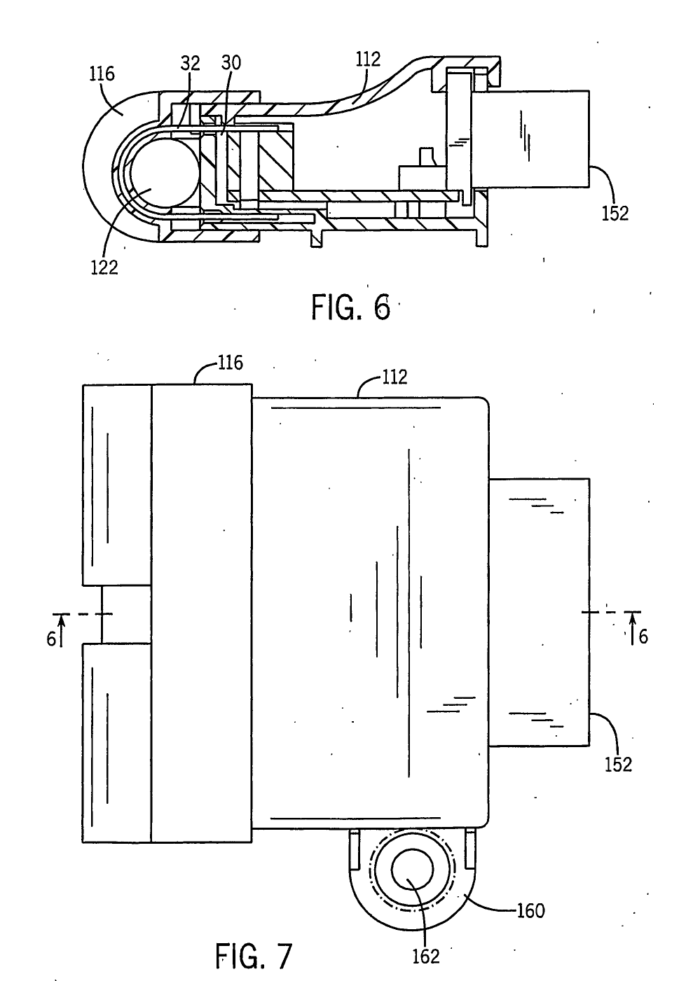

To assess the accuracy of calculated current values, battery monitoring system 10 infers a value for battery current based on the magnitude of a magnetic field generated or produced by a current flowing through a battery cable 40 (e.g., a wire or lead) coupled to a terminal of a battery. As shown in FIG. 6, battery monitoring system 10 includes an element 32 (e.g., a member or component such as an inductor) that senses or detects a magnetic field (e.g., flux in a magnetic field) generated by current flowing through battery cable 40. According to an exemplary embodiment, element 32 is shown as loop or core of magnetic (e.g., ferromagnetic) material.

Element 32 is coupled to a component 30 (shown as a Hall effect sensor) for determining the magnitude of current flowing through a battery cable based on the magnetic field detected by element 32. According to another exemplary embodiment, component 30 is a reed switch. It should be understood that while FIG. 6 relates to a different exemplary embodiment than is shown in FIG. 1, element 32 and Hall effect sensor 30 (or a reed switch) may be utilized in the embodiment shown in FIG. 1. Hall effect sensor 30 provides an output signal representative of the magnitude of battery current flowing through battery cable 40. This output signal may be utilized by the battery management system to assess the accuracy of calculated current values.

Battery monitoring system 10 is provided adjacent battery cable 40. According to an exemplary embodiment, a portion of battery cable 40 is received in an aperture 22 defined by a housing 16 for element 32 and a body 12 of battery monitoring system 10. According to an exemplary embodiment, housing 16 may be selectively positionable (e.g., by a hinge) such that battery monitoring system 10 is coupled or clamped to battery cable 40. For example, a hinge 18 (FIG. 3) may be provided to allow rotation of housing 16 about hinge 18 relative to body 12. In this manner, battery cable 40 maybe positioned within aperture 22 adjacent to housing 16 (and, accordingly, adjacent to element 32).

Current traveling through battery cable 40 creates a magnetic field that is detected by element 32 (e.g., the core captures or detects magnetic flux in the battery cable). Element 32 is coupled to Hall effect sensor 30, which then provides an output signal representative of the current traveling through battery cable 40. That is, based on the magnitude or other characteristic of the magnetic field detected by element 32, Hall effect sensor 30 infers or estimates the magnitude of current traveling or flowing through battery cable 40. Thus, in applications where the battery is charging or discharging, such charging or discharging current may be inferred based on the magnetic field generated by such current. According to another exemplary, a reed switch may be used in place of Hall effect sensor 30 to infer or estimate the magnitude of charging and/or discharging current.

Readings or output from Hall effect sensor 30 are taken at regular intervals (e.g., 5 to 10 seconds) and compared with calculated values for current (e.g., current calculated using formulae relating current to voltage, which is a measured input for the battery monitoring system). The inferred value for current may then be used to adjust the calculated current (e.g., to calibrate the calculated current) or to assess the accuracy of the current calculation. According to various exemplary embodiments, the inferred current may replace a calculated current, provide bounds for the calculated current, or may be used in addition to the calculated current (e.g., to provide a weighted average for the calculated current).

One advantageous feature of inferring a value for the magnitude of current flowing through a battery cable is that such a method eliminates the need to provide direct measurement of current transferred to or from a battery (e.g., using a current shunt or other similar detector), while still providing enhanced accuracy for current calculations utilized by battery monitoring system 10. Accordingly, battery monitoring system 10 may continue to utilize current calculations which depend on direct measurements of voltage, the accuracy of which may be relatively easily assessed.

The structure of battery monitoring system 10 includes housing 16 coupled to body 12 of battery monitoring system 10. Element 32 is contained within housing 16 and is positionable adjacent to battery cable 40 received in aperture 22. According to an exemplary embodiment, housing 16 is coupled to body 12 by a hinge 18 (see, e.g., FIG. 3) to allow rotation of housing 16 about hinge 18 for insertion and removal of battery cables (e.g., battery cable 40 shown in FIG. 1). According to another exemplary embodiment (see, e.g., battery monitoring system 100 shown in FIG. 5), a housing 116 for the core may be completely removable from a body 112 of battery monitoring system 100 (e.g., the housing may be slid away or decoupled from the body of the monitoring system). In such an embodiment, an aperture 122 is provided between housing 116 and body 112.

Aperture 22 has a size and/or shape configured to receive a particular size and/or shape of battery cable. According to an exemplary embodiment, a member or element such as an insert 20 may be provided in aperture 22 (see, e.g., FIGS. 1 and 3). In this manner, battery cables that have a smaller diameter than aperture 22 may be relatively securely retained by the battery monitoring system. Insert 20 includes a cutout or opening through which battery cable 40 may be provided. According to various exemplary embodiments, the size of the cutout or opening in the insert may vary. Further, the insert may be replaced with an insert having a different size cutout to accommodate a battery cable having different dimensions. Insert 20 may be made of a foam or rubber material. According to other exemplary embodiments, other materials may be used.

Battery monitoring system 10 is configured such that it may be relatively securely attached or coupled to a battery cable (e.g., battery cable 40). For example, the walls of aperture 22 may provide a clamping force on battery cable 40 to relatively securely fasten housing 16 and battery monitoring system 10 to battery cable 40. The size and/or shape of the cutout or opening formed in insert 20 may be adapted or configured such that the aperture 22 is properly sized to accommodate a particular battery cable.

Battery monitoring system 10 includes a connector or interface 52 in the form of a plug for providing or enabling communication with vehicle electronics and/or information systems. Such a connector provides electrical and/or informational communication between battery monitoring system 10 and various other systems of a vehicle (e.g., a vehicle bus, etc.). For example, connector 52 may provide an interface with a vehicle communication system such as a bus (e.g., a CAN bus, a J1850 bus, a LIN bus, etc.) or other electrical subsystem to obtain information in the form of signals representative of certain conditions (e.g., performance, operation, etc.).

Connector 52 may also provide signals to the vehicle communication or other subsystem. For example, if battery monitoring system 10 determines that the battery has a relatively low state of charge, a signal can be transmitted from battery monitoring system 10 to the vehicle communication system that may be utilized to instruct a vehicle system (e.g., a voltage regulator, etc.) to provide additional charge to the battery. A variety of other signals may be transmitted from or to the battery monitoring system utilizing connector 52.

Connector 52 may be either a female or male type pin connector (e.g., 9 to 15 pins). According to an exemplary embodiment shown in FIG. 1, connector 52 is a male type connector configured to receive a female connector or plug 52 that acts as a connection or interface with a vehicle communication system or other vehicle systems. According to another exemplary embodiment, connector 50 may be a male connector and connector 52 may be a female connector, such that the connector provided on or as part of body 12 is a female type connector (e.g., such as connector 152 in FIG. 5).

In addition to the female/male pin type connectivity between connector 50 and connector 52, one or more members or elements 54 in the form of clips or other connectors may be provided on one or more sides of body 12 of battery monitoring system 10. Such members 54 are configured to mate with complementary features provided on or as part of connector 50 (e.g., a flexible bar or member having a sloped end portion which is configured to be received by a complementary feature). In this manner, the connection or interface between battery monitoring system 10 and a vehicle communications system or other vehicle system may be relatively securely maintained.

A member or element (e.g., a structure) in the form of a mounting bracket 160 (see, e.g., FIG. 5) may be provided to provide coupling between the battery monitoring system and a vehicle component (e.g., a vehicle crossbar or other structure in a vehicle engine compartment, etc.) location in a vehicle according to another exemplary embodiment. An aperture or hole 162 is provided in mounting bracket 160 through which a connector (e.g., a pin, screw, bolt, or other connector) may be provided (not shown) to secure the battery monitoring system to a portion of a vehicle or battery.

Body 12 of battery monitoring system 10 contains or encloses various electronic components (e.g., computing devices such as a CPU, processor, microcomputer, controller, etc., memory devices such as a RAM, ROM, EEPROM, etc.) (not shown). The electronic components are responsible for performing all calculations for battery monitoring system 10 (e.g., for modeling and/or estimating various performance and operational characteristics of a battery, for providing output signals to a vehicle communications system, for receiving signals from various vehicle systems as inputs to various calculations, etc.). The electronic components are in communication with various vehicle subsystems to provide static and dynamic inputs for calculations and modeling functions (e.g., through communication via the connector for vehicle electronics and information systems). One such dynamic input is the charging and/or discharging current for the battery, which may be calculated using formulae relating voltage to current and/or utilizing an inferred current value from a signal provided by Hall effect sensor 30.

One or more of the algorithms used by battery monitoring system 10 to characterize (e.g., monitor, model, simulate, etc.) a battery (e.g., the performance, operation, and/or other characteristics of the battery) may require a value for charge and/or discharge current. Because current is not directly measured by battery monitoring system 10, current is calculated from voltage measurements (e.g., utilizing one or more formulae relating voltage to current).

Voltage measurements may be provided at regular intervals to provide real-time monitoring of battery performance and/or operation. According to other exemplary embodiments, a fixed value for the voltage may be used (e.g., as a static input). Calculations for charge and/or discharge current may utilize other battery parameters as well (e.g., temperature, time, resistance).

To determine the accuracy of calculated values for current, Hall effect sensor 30 is utilized. Housing 16 is coupled (e.g., clamped) to battery cable 40 such that battery cable 40 is provided through aperture 22. Current traveling through battery cable 40 creates or induces a magnetic field around battery cable 40 which is detected by element 32, which in turn communicates with Hall effect sensor 30.

Hall effect sensor 30 infers or estimates the magnitude of current traveling through battery cable 40 during charging and/or discharging of the battery based on the magnitude of the magnetic field induced by the current flow. Accordingly, current is not directly measured by battery monitoring system 10, but is instead inferred or estimated by Hall effect sensor 30 based on the magnitude of the magnetic field generated by current through battery cable 40.

According to an exemplary embodiment, Hall effect sensor 30 provides an estimate of the current traveling through battery cable 40 that is accurate to within between approximately 2 and 3 percent, and may be used to infer the magnitude of charging and/or discharging current for current values between approximately 1 and 400 amperes.

According to an exemplary embodiment, Hall effect sensor 30 infers a current value at predetermined intervals (e.g., every 5 to 10 seconds). According to another exemplary embodiment, Hall effect sensor 30 provides continuous monitoring such that current may be inferred instantaneously at any time.

The calculated value of charge and/or discharge current based on voltage measurements is compared to the value calculated by battery monitoring system 10 (based on one or more formulae relating measured voltage values to current) for the charge and/or discharge current. The inferred current value (from Hall effect sensor 30) is used to determine the accuracy of the calculated current value and/or to correct, supplement, or replace the calculated current value.

According to an exemplary embodiment, the inferred current value may replace the calculated current value in the various mathematical constructs used by battery monitoring system 10 where the values for inferred and calculated current differ. According to one embodiment, the inferred current value will be used to replace the calculated current value where the values differ by a predetermined amount (e.g., 50 percent or more). According to various other exemplary embodiments, a different threshold may be utilized (e.g., greater or less than 50 percent difference between the calculated and inferred current values) before the inferred current is used in place of the calculated current in the various mathematical constructs.

According to another exemplary embodiment, instead of replacing the value for calculated current, the inferred current and the calculated current may be combined to provide a weighted average for the current.

According to another exemplary embodiment, the inferred current may be used to provide bounds for the calculated current (e.g., where calculated current is 50 amperes and inferred current is 20 amperes, a limit of plus or minus 10 amperes may be provided, such that the current used by the battery monitoring system must be between 10 and 30 amperes—accordingly, the calculated current of 50 amperes would be limited to 30 amperes). The bounds may be provided in the form of a number (e.g., plus or minus a certain number of amperes) or as a percentage of the inferred current value (e.g., plus or minus 50 percent).

In this manner, the accuracy of values for calculated charge and discharge current may be assessed and corrected if necessary. Such method is applied at regular intervals (e.g., 5 to 10 seconds, etc.) to adjust the calculated (as opposed to measured) current values used by battery monitoring system 10 in various mathematical constructs.

The use of a battery monitoring system such as that described above may have a variety of advantageous uses. For example, as described above, the accuracy of current calculations based on voltage measurements may be assessed using a Hall effect sensor. In monitoring or modeling a new or unused battery, assessing the accuracy of current calculations in this manner may be particularly useful. In addition to such uses, the battery monitoring system may also be useful in estimating resistance changes in the system (e.g., a resistance change of a load in a vehicle electrical system), since such resistance change may be inferred based on current calculations made by the battery monitoring system. Assuring the accuracy of the current calculations in such applications may be useful to determine whether a particular load is functioning properly or is drawing an abnormally high or low amount of current, which may be indicative of a malfunction of the load.

According to another exemplary embodiment, a reed switch (not shown) may be used in place of a Hall effect sensor to infer charge and/or discharge current. Reed switches typically include reed contacts in a capsule, and a permanent magnet arranged for movement relative to the capsule. When a magnetic field provided near the capsule, the contacts are opened or closed.

The reed switch may comprise two “reeds” provided in a housing. Contacts are moved between an “off” or opened position and on “on” or closed position in response to a magnetic field (e.g., current flow in the battery cable). If the current flow (and corresponding magnetic field) is within a certain range of values, the contacts magnetize, flex and engage each other to allow the current to flow through the sensor. When the current flow is attenuated or outside the range of values, the contacts demagnetize, separate and disengage each other.

According to an exemplary embodiment, an inert gas or a vacuum is hermetically sealed within the housing to maintain the cleanliness of and protect the contacts. Calculated current values may be assessed for accuracy in a manner similar to that described above with respect to the use of Hall effect sensors.

The various elements of battery monitoring system 10 may be made of any of a wide variety of materials as are well known in the art. For example, body 12 may be made of a polymeric (e.g., a polypropylene-containing material) or composite (e.g., glass-reinforced polymer) material. Insert 20 may be made of a foam material (e.g., polystyrene, etc.), a rubber material, or any other suitable material.

Hall effect sensor 30 may be any type of commercially available Hall effect sensor. According to an alternative embodiment in which a reed switch or sensor is used in place of the Hall effect sensor, the reed sensor may be any commercially available type of reed sensor. One example of such a reed switch is a model number HSR003 micro-miniature reed switch rated at 5-20 ampere-turns commercially available from Hermetic Switch, Inc. of Chickasha, Okla., USA.

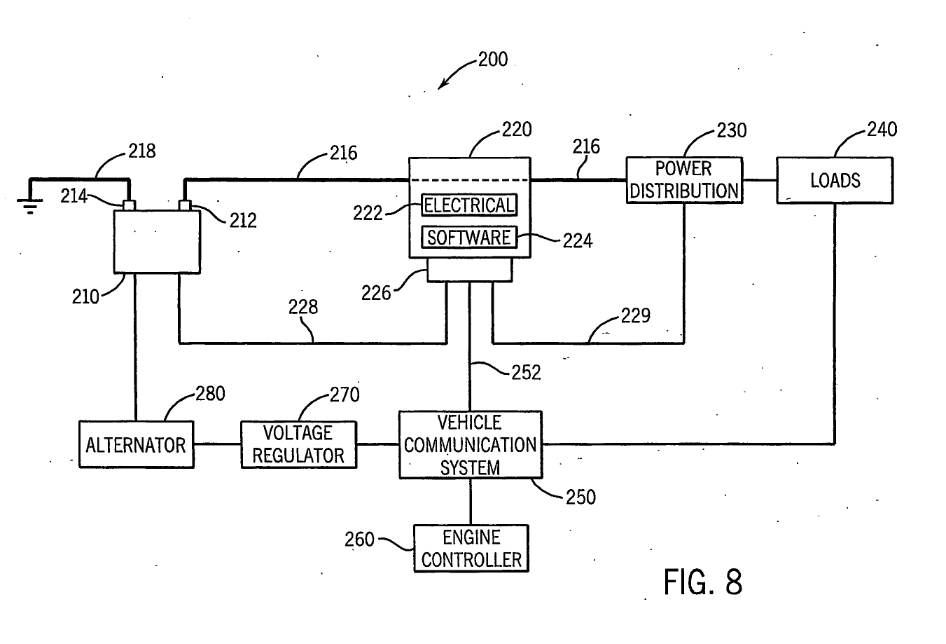

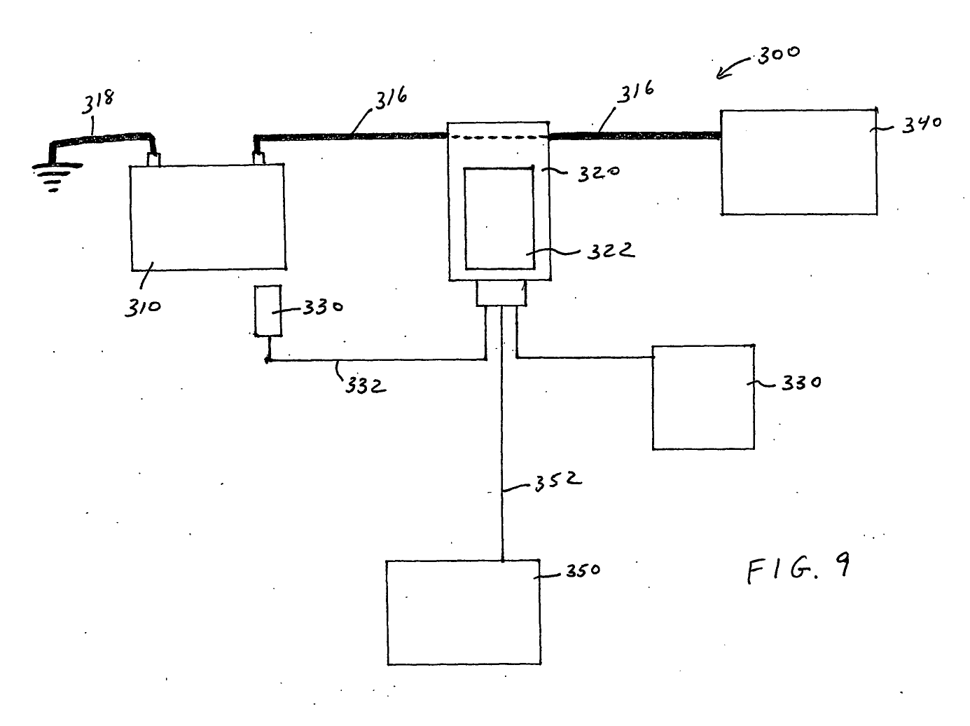

FIG. 8 shows a schematic block diagram of a battery system 200 utilizing a battery monitoring system 220 according to an exemplary embodiment. A battery 210 (e.g., a 12 volt battery, a 36 volt battery, etc.) has a battery cable 218 coupled between a negative battery terminal or post 214 of battery 210 and ground. According to an alternative embodiment, battery cable 218 may be coupled to a starter or other vehicle device or system. A battery cable 216 is coupled between a positive terminal or cable 212 and a power distribution system or box 230. Power distribution system 230 provides power to various vehicle loads 240.

Battery monitoring system 220 includes electrical components 222 and software 224. A connector or interface 226 (e.g., a 10 pin programmable output connector) is utilized to provide a communications interface with vehicle communication system 250 (e.g., a CAN bus, a LIN bus, a J1850 bus, etc.) through wire or line 252. Power for the various components of battery monitoring system 220 are received from power distribution system 230 through wire or line 229.

Software 224 includes code configured to perform the various calculations and run the various algorithms necessary to characterize, monitor, model, simulate, and/or manage battery 210. For example, software 224 may model and monitor the state of charge (SOC), state of health (SOH), and end of life (EOL) conditions of a battery. Software 224 may also include a learning capability so that the battery monitoring system will not need to be reset when a new battery is provided in the battery system 200.

Electrical components 222 may include any of a variety of electrical components as described above (e.g., CPUs, memory, controllers, etc.). According to an exemplary embodiment, a plurality of memory devices are provided (e.g., 48 KB Flash, 1 KB EEPROM, 1 K RAM). Various elements or components are also provided to infer current through the battery cable (e.g., a Hall effect sensor and a magnetic core in the form of a loop). Such elements may be utilized to assess the accuracy of and/or adjust current calculations based on voltage measurements made by the battery monitoring system.

Battery monitoring system 220 receives a plurality of inputs for use in the calculations performed by software 224. For example, battery temperature is monitored by way of a battery sensor connected to battery monitoring system 220 by a connection 228. The battery sensor may be a thermocouple or other temperature monitoring device coupled to an external surface of battery 210. Battery monitoring system 220 also may utilize other inputs (e.g., measured voltage, calculated current, etc.). Battery monitoring system 220 also is coupled to battery cable 216 (see, e.g., FIG. 1) to obtain an inferred current value based on the magnetic field generated when current flows through battery cable 216. Such inferred current value may be utilized to assess the accuracy of the calculated current value, replace the calculated current value, provide a bounds for the calculated current value, provide a weighted average for the current, etc.

According to an exemplary embodiment, battery monitoring system 220 determines when the charge available to be provided from battery 210 has reached a predetermined threshold (e.g., the battery charge is insufficient to provide cranking power for the vehicle). A signal may be transmitted from battery monitoring system 220 to vehicle communication system to operate a voltage regulator 270, which in turn acts to operate an alternator 280 to charge battery 210. Battery monitoring system 220 may also send signals to vehicle communication system 250 to operate an engine controller 260 or any of a variety of other electrical loads of the vehicle (e.g., loads 240, which may include any of a number of loads, such as electric windows and door locks, air conditioning systems, and/or any other electrical system in a vehicle requiring power).

Battery management system 220 may also provide various other outputs representative of battery operation, performance, features, recommendations, etc. to vehicle communication system 250. For example, battery management system 220 may provide output signals representative of deliverable power and energy of the battery, state of charge of the battery, state of health of the battery, end of life prediction for the battery, recommended battery charge voltage (e.g., level of charge voltage to obtain a particular fuel economy, to obtain a particular battery life, etc.), recommended start-stop capability, charge acceptance capability, operating history, warranty information, voltage, temperature, number of cycles, etc. It should be noted that while a variety of inputs and outputs for battery management system have been described, any of a variety of output signals (and/or combinations of output signals) may be provided by battery management system 220 to various vehicle systems, including vehicle communication system 250, according to a variety of exemplary embodiments.

While FIG. 8 illustrate loads 240 as being directly connected to power distribution system 230 and vehicle communication system 250, a relay or switch for each load may be connected to power distribution system 230 and to communication system 250 such that the relay provides a signal to the load. Accordingly, input signals from vehicle communication system 250 and power distribution system 230 may be received by a relay or switch for a particular vehicle electrical load, which may then act to operate the load in accordance with the signals.

FIG. 8 shows one exemplary embodiment of a battery system utilizing a battery monitoring system. According to other exemplary embodiments, other connections, devices, systems, etc. may be included in a battery system utilizing a battery monitoring system such as that shown and described herein. For example, a battery monitoring system may provide output signals directly to any of a variety of vehicle systems (e.g., instead of providing a signal for the vehicle system through a vehicle communication system such as a bus). In another example, a battery monitoring system may be used in conjunction with a battery system including a plurality of batteries (e.g., a dual-battery system).

FIG. 9 shows another exemplary embodiment of a battery system 300 utilizing a battery monitoring system 320 such as that described herein. Battery monitoring system 320 includes a module 322 that includes various components (e.g., electrical components, software, sensors such as Hall effect sensors, and/or other components, elements, or devices). Battery monitoring system 320 receives power from a power source or supply 330 (e.g., a power distribution system or box or other power source). Battery monitoring system is configured to receive one or more input signals from a sensor 330 (e.g., a temperature sensor, etc.) over a data link or connection 332. Sensor 330 is provided in the vicinity of a battery 310 and/or is coupled to battery 310. Battery 310 is connected to one or more loads 340 (e.g., vehicle electrical loads) either directly or through a power distribution system and/or other components (e.g., a relay or switch, etc.).

Battery monitoring system 320 is clamped or coupled to a battery cable such as that shown as battery cables 316 and 318. As described above with regard to the various other exemplary embodiments, battery monitoring system 320 does not interrupt the circuit formed by the battery cable, but rather couples to an external surface of the battery cable. Battery monitoring system 320 infers the magnitude of current traveling through the battery cable based on the magnetic field generated by such current. Battery monitoring system 320 provides output signals to a computing device, network, or other system 350 (e.g., a bus, etc.) over a data link or connection 352. Battery monitoring system 320 may also receive input signals from system 350 for use in various calculations or other operations. System 350 is configured to send signals to and/or receive signals from various vehicle components (e.g., to determine the operational status of the components, to provide instructions to operate the components, etc.).

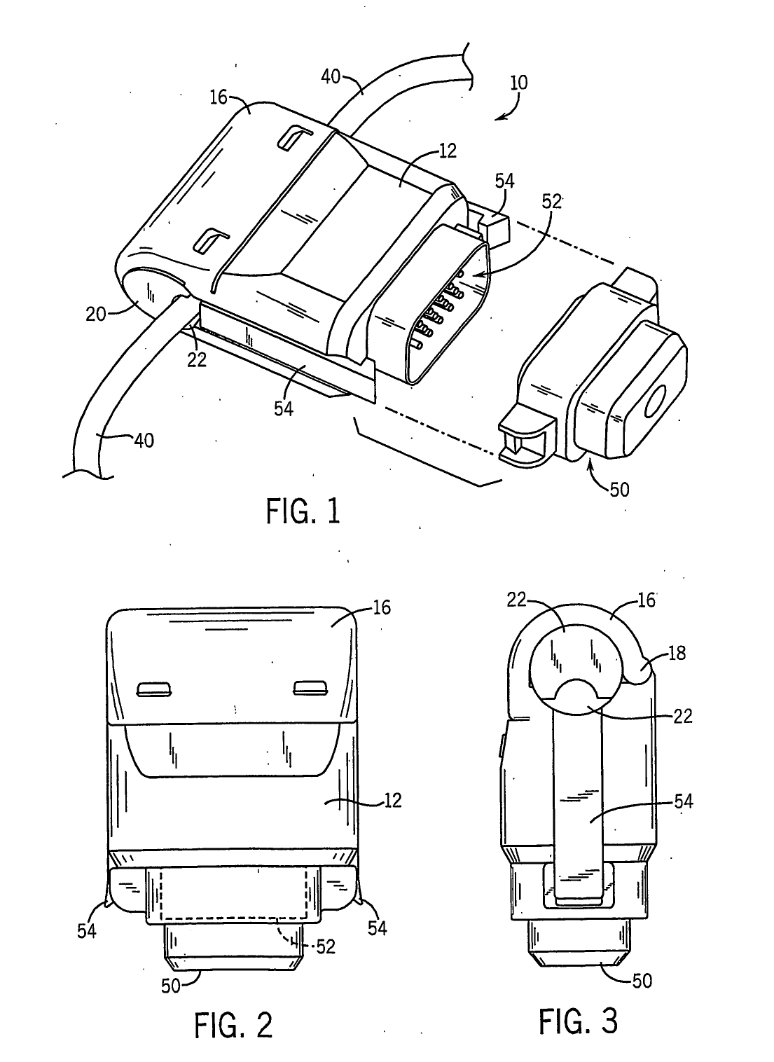

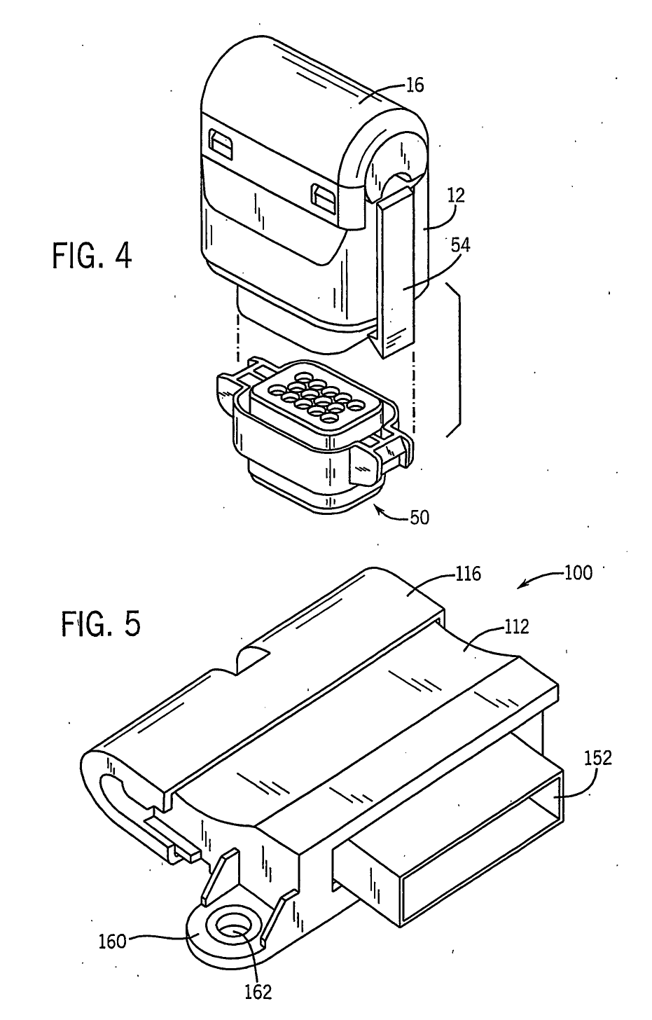

It is important to note that the construction and arrangement of the elements of the battery container as shown in the preferred and other exemplary embodiments is illustrative only. Although only a few embodiments of the present inventions have been described in detail in this disclosure, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter recited herein. For example, elements shown as constructed of multiple parts or elements may be integrally formed (e.g., instead of providing the connector for vehicle electronic and information systems as being formed of a separate piece, the connector may be integrally formed with the housing for electronics) or vice versa, the position of elements may be reversed or otherwise varied (e.g., male/female connectivity of the connectors may be reversed), and the nature or number of discrete elements or positions may be altered or varied (e.g., the number of pins in the connectors may be varied). It should be noted that the elements and/or assemblies of the system may be constructed from any of a wide variety of materials that provide sufficient strength or durability, including any of a wide variety of moldable plastic materials (such as high-impact plastic) in any of a wide variety of colors, textures and combinations. Elements and features shown and described with respect to one embodiment may be utilized in conjunction with the various other embodiments shown and described (e.g., a Hall effect sensor may be utilized with the embodiments shown in FIGS. 1-3, etc.). Other substitutions, modifications, changes and omissions may be made in the design, operating conditions and arrangement of the preferred and other exemplary embodiments without departing from the scope of the present invention.

What is claimed is:

1. A battery monitoring system comprising:
a component for determining the magnitude of current flowing through a battery cable based on a magnetic field produced by the current;
wherein the component is configured to provide an output signal representative of the magnitude of current for use in characterizing the battery.

2. The system of claim 1 wherein the component comprises a Hall effect sensor.

3. The system of claim 1 further comprising an element coupled to the component for detecting a magnetic field when the element is provided adjacent a battery cable.

4. The system of claim 3 wherein the element comprises a magnetic material.

5. The system of claim 3 further comprising a housing for containing at least a portion of the element.

6. The system of claim 5 wherein the system further comprises a body for containing electronic components and wherein the housing is coupled to the body.

7. The system of claim 6 wherein the electronic components are configured to perform calculations to characterize the battery.

8. The system of claim 6 wherein the housing is coupled to the body by a hinge.

9. The system of claim 6 further comprising an aperture defined by the housing and the body for receiving a battery cable therein.

10. The system of claim 9 further comprising an insert provided in the aperture, the insert including an aperture provided therein.

11. The system of claim 1 wherein the system further comprises a connector for providing an interface with a vehicle electrical system.

12. The system of claim 1 further comprising a structure for attaching the system to a vehicle component.

13. The system of claim 1 wherein system is configured for coupling to at least a portion of the battery cable.

14. The system of claim 1 wherein the component comprises a reed switch.

15. A method for characterizing a battery utilizing a battery monitoring system, the battery monitoring system adapted to characterize the battery utilizing at least one mathematical construct, the method comprising:
Inferring a magnitude of battery current based on a magnetic field generated by current flowing through a battery cable coupled to the battery.

16. The method of claim 15 wherein the battery current is selected from a charging current and a discharging current.

17. The method of claim 15 wherein the step of inferring the magnitude of battery current utilizes a Hall effect sensor.

18. The method of claim 15 wherein the step of inferring the magnitude of battery current utilizes a reed switch.

19. The method of claim 15 wherein the step of inferring the magnitude of battery current comprises detecting a magnetic field adjacent the battery cable and providing an output signal representative of the magnitude of the battery current based on the strength of the magnetic field.

20. The method of claim 15 further comprising utilizing the inferred magnitude of battery current in a mathematical construct utilized to characterize the battery.

21. The method of claim 15 further comprising calculating the magnitude of the battery current based on a voltage measurement to produce a calculated current value.

22. The method of claim 21 further comprising comparing the calculated current value to the inferred magnitude of battery current.

23. The method of claim 22 further comprising utilizing the inferred magnitude of battery current to determine the accuracy of the calculated current value.

24. The method of claim 21 further comprising utilizing a current value for a mathematical construct that is a weighted average of the calculated current value and the inferred magnitude of battery current.

25. The method of claim 21 further comprising utilizing the inferred magnitude of battery current to provide a limit for the calculated current value and utilizing the limited calculated current value in a mathematical construct for characterizing the battery.
